(19) United States
(12) Patent Application Publication
(10) Pub. No.: US 2007/0087140 A1
(43) Pub. Date: Apr. 19, 2007

(54) Insulating glass unit

(75) Inventor: Kati-Josef Dierks, Wetter/Ruhr (DE)

Correspondence Address: ROBERTS, MLOTKOWSKI & HOBBES, P. O. BOX 10064, MCLEAN, VA, 22102-8064, US

(73) Assignee: USD Formteiltechnik GMbH, Meinerzhagen (DE)

(21) Appl. No.: 10/596,201

(22) PCT Filed: Dec. 1, 2004
(86) PCT No.: PCT/EP04/13635

§ 371 Date: Jun. 2, 2006

(30) Foreign Application Priority Data
Dec. 2, 2003 (DE) 10356216.8

(51) Int. Cl. E06B 3/00

(52) U.S. Cl. 428/34

(57) ABSTRACT

An insulating glass unit having at least two glass panes, a fastener for fixing the position of the glass panes and a sealing element for setting a distance between two neighboring panes and for gas-tight, lateral insulation of the pane intermediate space enclosed by the panes, the sealing element containing at least one gas-tight middle part and two lateral gap seals, each of which is situated in the area between one of the glass panes and the middle part, at least one diffusion-tight cushion, which is essentially made of an elastic material, being situated in the area between the two gap seals of the sealing element. The inner surfaces of the cushion preferably have a metal layer vapor-deposited on them. In a preferred embodiment, the fastener is a metal clamp externally enclosing the panes which enables the insulating glass unit to be manufactured essentially without adhesive.

### BACKGROUND OF THE INVENTION

1. Field of the Invention

The present invention relates to an insulating glass unit having at least two glass panes, a fastener for fixing the position of the glass panes, and a sealing element for setting a distance between two neighboring panes and for gas-tight lateral insulation of the pane intermediate space enclosed by the panes. In particular, the present invention relates to such an insulating glass unit, in which the sealing element contains at least one gas-tight middle part and two lateral gap seals, each of which is situated between a glass pane and the middle part.

2. Description of Related Art

As also described in German industrial standard (DIN) 1259, part 2, in such a glazing unit, also referred to as multi-pane insulating glass, glass panes made of window glass mirror glass, cast glass, flat glass, or similar glasses are typically used. The glass panes are separated from one another by one or more intermediate spaces filled with air or gas and are sealed airtight or gas-tight and moisture-tight at their edges. The edge seal is of great significance for the operational capability of the insulating glass unit. If it leaks, inter alia, the thermally insulating gas filling may escape, for example, or moisture may collect in the insulating glass unit and condense on the interiors of the panes. The insulating glass unit then becomes “blind,” no longer insulates as desired, and is typically irreparably damaged. As a result, an insulating glass unit is of higher quality the tighter and longer-lived the edge seal of the pane intermediate space is.

Normally, the edge seal comprises a sealing element and a fastener. The sealing element runs around the outer circumference, preferably parallel to the glass pane edges, and typically comprises a middle part and two gap seals located laterally on the middle part and oriented toward each of the two glass panes. The middle part, also referred to as a spacer, is typically a hollow profile made of a gas-tight material, such as steel or aluminum. In order to remove water vapor from the pane intermediate space, which has possibly entered during production or because of leaks, a desiccant, such as a molecular sieve, is introduced into the cavity to absorb water vapor. However, massive middle part profiles made of a thermoplastic having incorporated desiccants are also known.

In order to terminate the areas between the middle part and the two neighboring glass panes gas-tight, gap seals are situated here. The gap seals are predominantly manufactured from polyisobutylene (“butyl”). This is a thermoplastic synthetic rubber which adheres well to glass and has a very low water vapor diffusion coefficient. The polyisobutylene may either be inserted as a pre-profiled cord between the panes in the middle part or introduced with the aid of an extruder into the gap area. In addition to sealing the gap, which is also referred to as a diffusion gap, the polyisobutylene seal is also used as a fixing aid during the production of the insulating glass units. However, because of its low material strength, the gap seal cannot contribute to the mechanical strength of the edge connection.

Therefore, a fastener is additionally situated to hold the glasses and the sealing element together permanently. Since the late nineteen-sixties, an elastic adhesive has been used as a fastener. This is applied externally to the sealing element and between the glass pane edges, which extend outward beyond the sealing element, while the glasses are pressed from the outside against the sealing element. After curing, the adhesive acts like a spring which presses the panes against the sealing element, through which diffusion gap widths of less than 0.5 mm width are achieved in the normal state. In the related art, in addition to single component (1-C) silicone and hot-melt butyl adhesives, two-component (2-C) adhesives have also proven themselves as fasteners. 2-C polysulfide and 2-C polyurethane adhesives, which have a high strength and elasticity with a relatively low water vapor diffusion coefficient, through which these also unfold an additional sealing effect, are especially widespread.

In order to be permitted by the building inspection authorities, the insulating glass units must withstand systematic tests in many countries. The systematic tests simulate the stress situations of an insulating glass unit in a shortened process. For this purpose, greatly varying temperature, pressure, UV radiation, weathering (rain) effects and stresses are typically simulated. In Germany, an insulating glass unit must currently meet the systematic test requirements of DIN 1286, but in future, it will have to meet the European standard prEN 1279. In general, the insulating glasses are to fulfill requirements for the gas loss rate, the sealant adhesion, the fogging safety, i.e., safety against out-gassing of foreign materials, which are deposited in the pane intermediate space as mist, the water vapor absorption of the desiccant, the UV stability, the stability of the sealing unit, in particular, the stability of the spacer profiles, the productive processing ability in the insulating glass manufacturing, the ability to manufacture models, the installation capability of transoms, and the ability to manufacture skylights and glass facades, in which the insulating glass units are attached to a support construction lying behind the glass unit (structural glazing).

With the introduction of prEN 1279, the requirements for the tight sealing of the insulating glass unit are sharpened, in particular, by greatly shortened cycle times of the different stress cases. It has been shown that the currently typical insulating glasses generally do not meet this standard, in particular, in the event of air pressure changes rapidly following one another.

In general, pressure changes result in deformations of the insulating glass units. If the external air pressure changes rapidly between high and low pressure, as during systematic tests, for example, “pumping” of the insulating glass units occurs. The glass panes of the insulating glass unit bulge alternately inward or outward as a function of the changing barometric air pressure. This behavior of the insulating glass units is caused because the pane intermediate space is hermetically isolated in relation to the surrounding atmosphere and no pressure equalization may occur in the event of changing barometric pressure.

FIG. 7 shows a pane edge of a typical insulating glass unit 1 of the related art in the deformed state when the outer air pressure is lower than the filling pressure in the pane intermediate space SZR. Because of the low external pressure, the two spaced glass panes 2, 3 bulge outward. Thus, the glass unit 1 assumes a convex shape, the two spaced glass panes 2, 3 rotating around the outer edges of the rigid middle part 6 of the sealing element 5 and their outermost pane edges compressing the fastener 4 (a 2-C adhesive here, for example). Presumably, because the fastener adhesive 4 has a relatively large internal pressure resistance, the panes 2, 3 may lever off of the spacer 6 at the outermost edge. Because of the low tensile strength of the polyisobutylene seals 7, 8, the seals 7, 8 detach easily, as shown in FIG. 7. Depending on where the adhesion of the gap seals 7, 8 is first exceeded, the seal 7 or 8 detaches either directly from the glass pane 3 or from the side of the spacer 6. In any case, the diffusion gap between the sealing element 5 and the particular glass pane 2, 3 is enlarged, and the leakage rate between the sealing element 5 (spacer 6) and the glass panes 2, 3 increases.

If the external air pressure is increased in such a way that a higher pressure exists outside the insulating glass element 1 than in the pane intermediate space SZR, the, glass element 1 assumes a concave shape. This results in the fastener 4 being subjected to tension in the edge area, while the gap seal 7 or 8 is compressed. In the event of especially large pressure load on the gap seal 7, 8, there may be damage to the adhesive effect of the gap seal 7, 8 on the spacer 6. If the load direction, i.e., the air pressure, then subsequently changes, the gap seal 7 or 8 will detach from the spacer 6 as a result and the leakage is amplified further.

The related art also has the disadvantage that the use of adhesive for fixing the panes slows the manufacturing of the insulating glass unit and additionally stresses the environment. After the adhesive has been applied in the pane intermediate space between sealing element and pane outer edges, it must first cure before the insulating glass unit may be processed further or transported. Outgassing of the adhesive itself and solvent vapors of solvents, which must be used for cleaning the devices carrying the adhesive and for removing adhesive residues, strains the environment and manufacturing personnel. The components of the insulating glass units of the related art which are glued to one another are additionally unsuitable for recycling.

### SUMMARY OF THE INVENTION

The object of the present invention is therefore to provide an insulating glass unit which is simple and cost-effective to manufacture, and which has a sufficiently tightly sealed pane intermediate space even in the event of frequent and rapid air pressure changes. Furthermore, the insulating glass unit according to the present invention is to be producible using a minimum of adhesive.

This object is achieved by the insulating glass unit as described below.

The insulating glass unit according to the present invention has at least two glass panes, a fastener for fixing the position of the glass panes and a sealing element for setting a distance between the glass panes and for gas-tight lateral insulation of the pane intermediate space enclosed by the glass panes. The sealing element contains at least one gas-tight middle part and two lateral gap seals. The gap seals are each situated in the area between one of the glass panes and the middle part, at least one diffusion-tight cushion, which essentially comprises an elastic material, being situated in the area between the two gap seals of the sealing element. The cushion is situated so that it directly adjoins the middle part and presses directly against one of the two gap seals.

The cushion ensures that distance changes between the panes and/or twists of the panes which may result from air pressure changes, for example, are transmitted to the cushion and compensated for there. The cushion is expediently installed between the panes under compressive stress, so that movements of the panes are introduced directly into the cushion. Pane movements, then, do not cause any noticeable change of the diffusion gap between glass pane and sealing element, and overstress of the gap seals or detachment of the gap seals from the panes is effectively avoided.

A diffusion-tight cushion is preferably situated between each of the two gap seals and the middle part of the sealing element directly adjoining the gap seal and the middle part. It is thus possible to use a typical spacer as the middle part for the sealing element, on each of whose sides facing toward the two glass panes a cushion is situated. Therefore, each gap seal has a cushion assigned directly thereto, and movements of the panes are introduced directly via the gap seal into the particular cushion. This also has the advantage that movements of a single pane may be damped in the cushion decoupled from the diametrically opposite pane.

In order that the cushion may deform sufficiently under the typical air pressure changes, it is preferably made of a material having a Shore A hardness in accordance with DIN 53505 of 50 N/mm² to 70 N/mm². To ensure its usage capability, the material is to remain essentially permanently elastic even over a long period of time, e.g., for more than 20 to 25 years, and only display slight plastic deformations over this period of time, if at all. Therefore, the cushion is advantageously made of an elastomeric plastic, in particular EPDM, polyurethane, an acrylonitrile butadiene elastomer, a chlorobutadiene elastomer, a fluoroelastomer, or a silicone. An embodiment made of EPDM is especially preferable. This is a synthetic high-performance rubber made of ethylene, propylene, and diene monomers. EPDM remains elastic over decades and has already been successfully used in sealing lips in aluminum or wood windows.

It is decisive for the tightness of the sealing element that, in addition to the middle part, the cushion is also gas-tight. In most cases, the diffusion tightness of the above-mentioned materials is sufficient for sealing the pane intermediate space. If greater tightness is desired, the buffer may be provided with a gas-tight layer on at least one surface, in particular, a metal layer. Metal-coated plastics are already known in high-vacuum sealed food packages. For this purpose, the relevant surface of the cushion is expediently metal plated using vapor-deposition or dry galvanized. Pre-finished thin films may also possibly be laminated onto the cushion. The gas-tight layer may, in turn, comprise multiple individual layers. In order to effectively prevent permeation of water vapor, an overall layer thickness of the gas-tight layer in the nanometer range suffices. Suitable layer thicknesses for a metal coating are approximately in the range between 40 and 200 um, a stainless steel preferably being used as a metal.

It is especially expedient if the gas-tight layer is applied to the surface of the cushion facing toward the inner pane intermediate space. In addition to the advantages already described, this position has the additional positive effect that vapors of the cushion are not released into the pane intermediate space.

Furthermore, it is advantageous if the cushion is extruded or vulcanized onto the middle part. This guarantees a gas-tight bond of the buffer to the middle part. In this case, the surface of the cushion is expediently sealed gas-tight (metallized) only after the extrusion, which then also seals the transition area cushion-middle part. It is especially expedient to seal both the exterior and also the interior of the cushion gas-tight. Finally, it is noted, once again, that the gas-tight coating may be a suitable measure for increasing the gas tightness, but is not absolutely necessary. Rather, there are also materials for the cushion which allow an effective vapor barrier even without metal coating.

In a preferred embodiment of the insulating glass unit according to the present invention, the gap seal is manufactured from a synthetic, in particular elastomeric plastic having a very low diffusion rate. Polyisobutylene having a water vapor diffusion rate of approximately 0.1 g/dm²/K is preferably used here. It is advantageous, in this case, if the gap seal lies at least partially in a trough of the sealing element. The gap seal is then enclosed on all sides by glass pane and sealing element. This effectively prevents the gap seal from shifting, being crushed, or dissolving, as occurs with polyisobutylene under high pressure in particular. The trough is preferably to be implemented in such a way that parts of the sealing element which delimit the trough on the top and/or bottom press directly against the glass pane. The troughs are expediently situated in the lateral areas of the cushion of the sealing element.

The trough may be incorporated into the cushion pressing against the glass pane. In order to provide a trough of this type in an especially simple and cost-effective way, however, the cushion expediently comprises at least two profiled strips situated neighboring one another. This has the advantage that commercially available elastomeric profiled strips, for example, having a triangular, semicircular, or even rectangular cross-section, may be used. These profiled strips may either be glued using an adhesive to the middle part and/or to one another or may be assembled directly via a gap seal made of polyisobutylene. If necessary, they may also be used entirely without adhesive in the sealing element. In any case, only a minimum quantity of adhesive is required for their attachment, which—compared to the quantity which has been used until now for pane fixing—practically does not come into consideration. In addition, the sealing element may already be pre-manufactured, so that delays because of curing times do not occur during the manufacturing of the insulating glass unit.

The widths of the profiled strips do not necessarily have to add up to the overall height of the middle part which they neighbor. It is also possible to situate the profiled strips at a distance from one another on the middle part of the sealing element. A variation in which the gap seal is framed between two profiled strips and also adjoins the middle part is also conceivable, for example. However, in this case, it is to be ensured that the width of the gap seal is selected broad enough for a secure seal of the pane intermediate space. If the profiled strips are situated neighboring one another at a distance, preferably on the outermost edges of the sealing element, width differences of different sealing elements may be equalized easily without having to use an individually tailored elastomeric cushion for each type and size of sealing element.

Preferably, a profile having high transverse strength and gas tightness is used for the middle part of the sealing element. Metal profiles are especially advantageous here, since they have a high structural strength and may be processed well. Hollow profiles which may receive the desiccant, which is used for absorbing water vapor, in their cavity, are preferred. In order that the desiccant may absorb and bind this water vapor, it is advantageous to open the hollow profile toward the pane interior side.

In order to reduce the quantity of adhesive in the pane intermediate space, it is preferred, according to the present invention, that no adhesive be used for fixing the panes, but rater at least one clamp be used, which is particularly made of metal. This clamp encloses the glass panes situated at a distance from one another from the outside and presses them against the sealing element. In other words, there is preferably essentially no adhesive in the space between the panes. “Essentially no adhesive” means here that small quantities of adhesive are provided in any case for attaching the individual components of the scaling element to one another. In particular, however, no adhesive and also no other sealing compound made of plastic is provided in the area between the exterior of the sealing element and the pane edges in the pane intermediate space in order to fix the panes in relation to one another and additionally to seal them in relation to one another. Therefore, the panes may no longer rest on an adhesive or plastic edge on their edges. The levering arising during “pumping” of the insulating glass panes, which frequently results in tearing of the gap seals, may therefore be effectively prevented. In addition, the entire insulating glass unit may be produced practically adhesive-free, because of which the insulating glass units according to the present invention may be produced more rapidly, with better quality, more cost effectively, and more environmentally compatibly.

Specifically, the more rapid production results because the insulating glass is already finished directly after the application of the fastening clamps and the otherwise typical bonding times of the adhesive no longer have to be maintained. The quality of the glass units is improved because dosing variations during mixing of the two-components and accompanying variations of the adhesive strength of the fastening agent no longer occur. The sealing element may also be situated further out on the glass pane edge, since the clamps achieve their retention force from the spring effect and not, like the adhesive, via the contact area. This advantageously enlarges the insulated area of the insulating glass element according to the present invention in relation to the known elements. Furthermore, intermediate storage areas (for the curing of the adhesive) and adhesive and dosing machines may be dispensed with, which allows the production to become more cost-effective. Finally, the insulating glass unit is produced in a more environmentally friendly way, not only the adhesive itself but rater also the cleaning of production means and tools being dispensed with.

Because two-component adhesives are dispensed with, above all, no chlorinated hydrocarbons and no aromatic solvents are required for cleaning machines and mixing lines. Toxic isocyanate and mercury residues no longer arise during the production if polyurethane-based (PU) adhesives are used and manganese oxides no longer arise in the event of gluing using polysulfide-based (PS) adhesives. Furthermore, the insulating glass units according to the present invention may be recycled better after the removal of the clamps, since all components are immediately available again sorted by grade.

In an expedient embodiment, the clamps enclose the entire outer edge of the insulating glass unit. A continuous and uniform peripheral compression of the pane edge may thus be guaranteed, and the metal clamps also function as a further sealing line and edge protector. Such an edge protector is used for protecting the insulating glass unit from damage, and in addition, for protecting the people handling the insulating glass unit from cuts due to the very sharp-edged glass panes. Many fastening possibilities of the glass units also result through the strapping with the metal band and installation in plastic, wood, or aluminum windows is improved. If only metal and possibly gas-tight coated cushions are installed except for polyisobutylene, the insulating glass unit according to the present invention is also outstandingly usable in highly loaded roof areas and in structural glazing constructions.

The clamps preferably have a U-shaped cross-section having a front side and two leg sides pressing against the glass panes. During assembly of the insulating glass units, either already pre-manufactured peripheral frames having an L-shaped starting profile are folded into the U-shape around the inserted glass panes, or the U-profile is folded from strip steel directly around the glass pane edges, or profiles which are already U-shaped are pushed onto the pressed-together glass element edges. In any case, it is advantageous if the outer edges of the leg sides press against the glass panes, since a relatively large retention force is thus developed. It is especially advantageous if at least one of the leg sides of the clamps has at least one bulge toward the pane. This bulge concentrates the pressure on the pane and the sealing element lying behind it.

Furthermore, it is advantageous if the clamps also have at least one bulge on their front side. This bulge is typically a fold which ensures that the clamps act like a spring. During the manufacturing of insulating glass unit, the clamp is pulled apart in the direction of its leg sides, pushed in the stretched state onto the edge of the insulating glass unit, and then relaxed. Because of the front fold, the clamps will contract and exert the desired contact pressure on the pane exteriors. The glass panes are thus pressed against the sealing element, the cushion and the gap seals are brought to tension, and the pane intermediate space is effectively sealed.

In an especially preferred embodiment of the insulating glass unit, the fastener for fixing the position of the glass panes comprises multiple clamps and a tension band. Thus, instead of a single peripheral clamp, multiple short clamps situated at a distance from one another are used. The tension band is guided externally on the clamps and around the edges of the glass panes and tensioned. The clamps are thus pressed by the tension band onto the pane edges, and thus, effectively prevent the panes or the clamps from shifting in relation to one another The tension band expediently runs in bulges on the front sides of the clamps which correspond as much is possible to the cross-sectional shape of the tension band. The tension band is thus secured against slipping off of the clamps or the insulating glass unit.

Special beveled corner clamps which abut one another at the corners are situated on the comers of the pane edges. The tension band is thus guided continuously around the corner areas of the glass panes and is protected especially well there—from fraying, for example. The tension band itself may be made of material having high tensile strength such as stainless steel, webbing, or something similar and may have a rounded or, especially expediently, polygonal cross-sectional shape which is as flat as possible. It is especially positive in this clamped embodiment of the insulating glass unit according to the present invention that less material is required for the clamps. and the unit is thus to be produced more cost-effectively. In addition, production which uses the clamped insulating glass unit may be tailored significantly more easily to changing pane sizes or geometries. This embodiment is therefore also especially well suitable for insulating glass units which are produced only in a small piece count or deviating from a rectangular exterior shape, for example.

Overall, the insulating glass units according to the present invention have the advantage that they have a very similar basic construction to the insulating glass units of the related art. Thus, significantly improved insulating glass elements may be manufactured with the same assembly in principle on already existing manufacturing facilities and from typical materials and components, such as spacers, etc.

The present invention will be explained in greater detail in the following with reference to the accompanying drawings.

### BRIEF DESCRIPTION OF THE DRAWINGS

FIG. 1 schematically shows a section through the edge of a first exemplary embodiment of an insulating glass unit according to the present invention;

FIG. 2 schematically shows a section through the edge area of the first exemplary embodiment when it is deformed convexly by low external air pressure;

FIG. 3 schematically shows a section through the edge area of a second exemplary embodiment of an insulating glass unit according to the present invention;

FIG. 4 schematically shows a detail of a section through the edge area of a third exemplary embodiment of an insulating glass unit according to the present invention;

FIG. 5 schematically shows a section through the edge area of a fourth exemplary embodiment of an insulating glass unit according to the present invention;

FIG. 6 schematically shows a side view of the fourth exemplary embodiment of the insulating glass unit shown in FIG. 5; and

FIG. 7 schematically shows a section through the edge area of an insulating glass unit according to the related art when it is deformed convexly by low external air pressure.

### DETAILED DESCRIPTION OF THE INVENTION

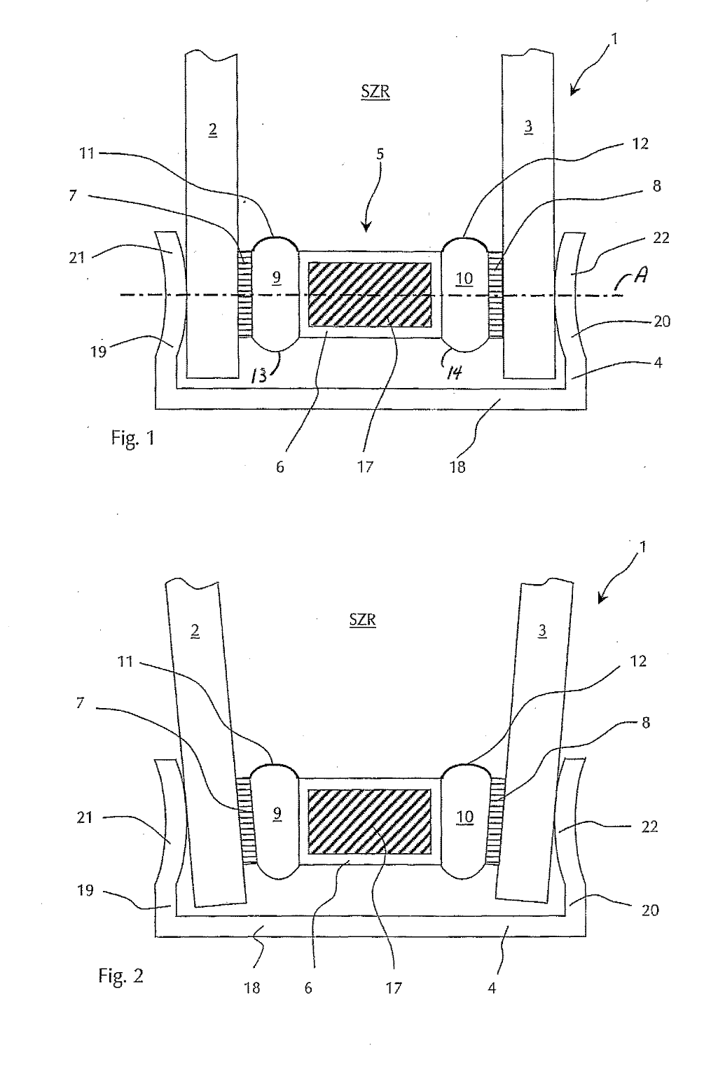

FIG. 1 schematically shows a first exemplary embodiment of an insulating glass unit 1 according to the present invention in which a sealing element 5 is situated between the outer edges of two glass panes 2, 3. and which seals the pane intermediate space SZR between the panes 2, 3 relative to the environment. Argon is concentrated in the pane intermediate space SZR for insulation. The insulating glass unit is held together on its edge by a peripherally continuous clamp as the fastener 4. In this exemplary embodiment, the sealing element 5 comprises a centrally situated middle part 6 having a cavity 17 which is filled with a desiccant. Two cushions 9, 10 are extruded onto both sides of the middle part 6, each of which faces toward the respective glass pane 2, 3. Both of the cushions have a metal layer 11, 12 vapor-deposited on their surfaces which face toward the pane intermediate space SZR. These metal layers. 11, 12 are gas-tight and prevent argon from diffusing out through the elastic cushions 9, 10, and prevent air and water vapor from diffusing in. A gap seal 7, 8, made of polyisobutylene is attached to the side of each of the cushions 9, l 0 that faces toward the panes 2 or 3, respectively. These polyisobutylene seals 7, 8, prevent a gas exchange along the contact faces of the sealing element 5 and the glass panes 2, 3, respectively.

During assembly of the insulating glass unit, the two glass panes 2, 3 are pressed together from the outside and the fastening clamps 4 are pushed onto the edge where they are held under tension. In the installed state, the clamps 4 press the two glass panes 2, 3 against the sealing element 5. The elastic cushions 9, 10 are thus compressed, because of which movements of the panes 2, 3 are transmitted directly via the polyisobutylene seals 7, 8 to the respective cushion 9, 10. The cushions 9, 10, thus, permanently exert pressure on the gap seals 7, 8, respectively, because of the compression, and thus, conduct possibly occurring tensile stresses into the gap seals 7, 8.

It is advantageous if bulges 21, 22 of the diametrically opposing legs 19, 20 of the fastening clamps 4 extend linearly, parallel to the edge of the glass unit and lie as much as possible at the same height. The diametrically opposing panes are thus pressed against one another in a plane “A” running parallel to the edge. In order to reduce unfavorable tensile forces on the sealing element 5, it is also situated having its center of gravity axis in the plane “A”. Enlargements of the diffusion gap are thus already reduced in geometric ways by avoiding unfavorable lever effects of the fastening element.

In this exemplary embodiment, the width of the middle part is between 10 mm and 16 mm and the width of the sealing element is between 14 mm and 20 mm. The height of the sealing element, and thus, also the gap seals 7, 8, is approximately 6 mm, doubled in relation to the typical dimensions. The interior width of the clamps is 20 mm to 30 mm at a leg exterior length of 5 to 8 mm and a thickness of the clamps is approximately 0.8 mm to 1 mm.

Because, at 6 mm, the diffusion gap is twice the height of the known insulating glass units, the leakage rate of the sealing unit 5 has been further reduced. Thus, in the known systems, gas leakage rates of over 1% per year exist. Since the k-value no longer changes at a gas filling rate of 60% argon in the pane intermediate space, the intermediate space is typically overfilled with more than 90% argon, in order to arrive at an operational capability of the insulating glass unit 1 of more than 25 years. Because of the reduced leakage rate, it is no longer necessary in the insulating glass units 1 according to the present invention to overfill the pane intermediate space SZR with more than 90% argon, and/or a significantly lengthened operational capability of the insulating glass units results at the same rate of overfilling.

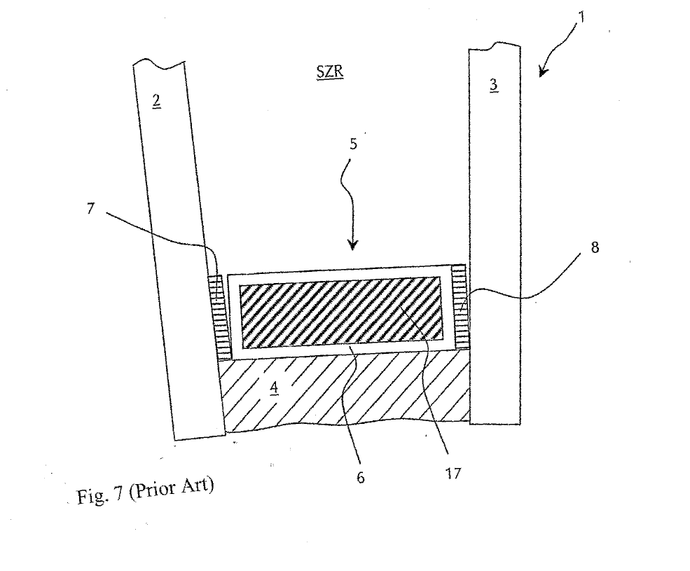

FIG. 2 shows the pane edge of the first exemplary embodiment of the insulating glass unit 1 according to the present invention shown in FIG. 1 in the deformed state. The deformed state shown corresponds to a deformation of the insulating glass unit when the exterior air pressure is lower than the filling pressure in the pane intermediate space SZR. In relation to the related art, the insulating glass unit 1 according to the present invention has the advantage that the glass panes 2, 3 no longer have their outermost edges placed on the fastening element 4 and are no longer able to lever off via the sealing element 5. Rather, the bulges 21, 22 ensure that the movement of the glass panes 2, 3 plays out essentially in the center of gravity axis “A” of the sealing element 5. Since the panes 2, 3 are also pressed together at these points, it is possible to effectively reduce the tensile stresses on the polyisobutylene seals 7, 8, because the required deformation pathways are provided by the elastic cushions 9, 10. In other words, the cushions 9, 10 are compressed on their exterior sides 13, 14, while they are pulled on their interior sides 11, 12, and thus, relieve the polyisobutylene seals 7, 8. This results in a significantly increased tightness of the insulating glass unit 1 according to the present invention in relation to the known insulating glass unit of the related art shown in FIG. 7.

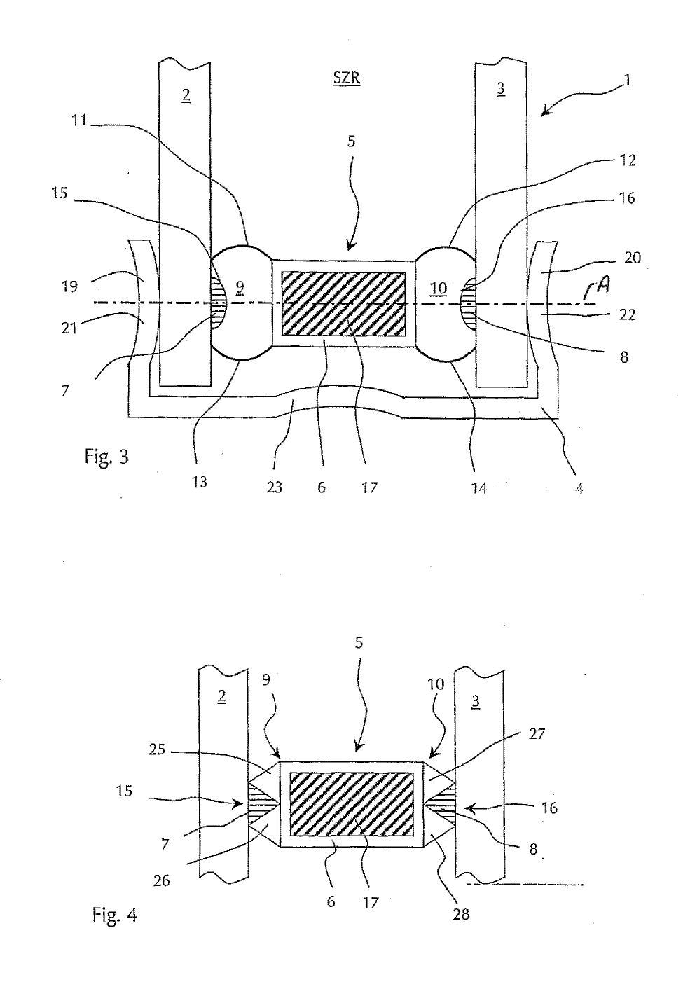

FIG. 3 shows a second exemplary embodiment of the insulating glass unit according to the present invention. In order to prevent displacement or pushing away of the gap seals made of polyisobutylene 7, 8, in this exemplary embodiment, the gap seals are situated in troughs 15, 16. The edges of the elastomeric cushions 9, 10 delimiting the troughs press directly against the glass panes 2, 3 and prevent the polyisobutylene from being compressed and exiting laterally.

In this exemplary embodiment, the elastomeric cushions 9, 10 have metal vapor-deposited not only on the sides 11, 12 facing toward the pane intermediate space SZR, but also on the sides 13, 14 facing away from the pane intermediate space SZR. This effectively prevents gases from escaping out of the cushions or diffusing through the cushions.

The peripheral clamp 4 completely enclosing the edge of the insulating glass unit 1 has a bulge 23 on its front side 18 in this exemplary embodiment, which gives the clamp 4 a spring effect. During the manufacturing, the clamp is pulled in the direction of its two exterior legs 19, 20 and pushed laterally onto the pane edges. By relaxing the clamp 4, it contracts because of the spring effect of the bulge 23, and the leg interiors 19, 20 press against the glass panes 2, 3 and clamp the sealing element 5. The middle part 6 of the sealing element 5 used in this exemplary embodiment is a commercially available hollow spacer made of metal, whose interior 17 is also filled with a desiccant.

FIG. 4 shows a detail of an especially preferred third embodiment of an insulating glass unit according to the present invention, in which the cushions 9, 10 of the sealing element 5 each comprise two prismatic elastomeric profiled strips 25, 26 and 27, 28. The clamp 4 located on the edge is not shown in this illustration, although this embodiment is also a clamped insulating glass unit 1 The cushioning strips 25, 26 and 27, 28 are each situated in pairs next to one another in such a way that a trough 15 or 16 having a triangular cross-section results between them in each case. A gap seal 7, 8 made of polyisobutylene is situated in each trough 15, 16. The cushion surfaces facing toward the pane intermediate space SZR are not provided with a metal coating in this embodiment.

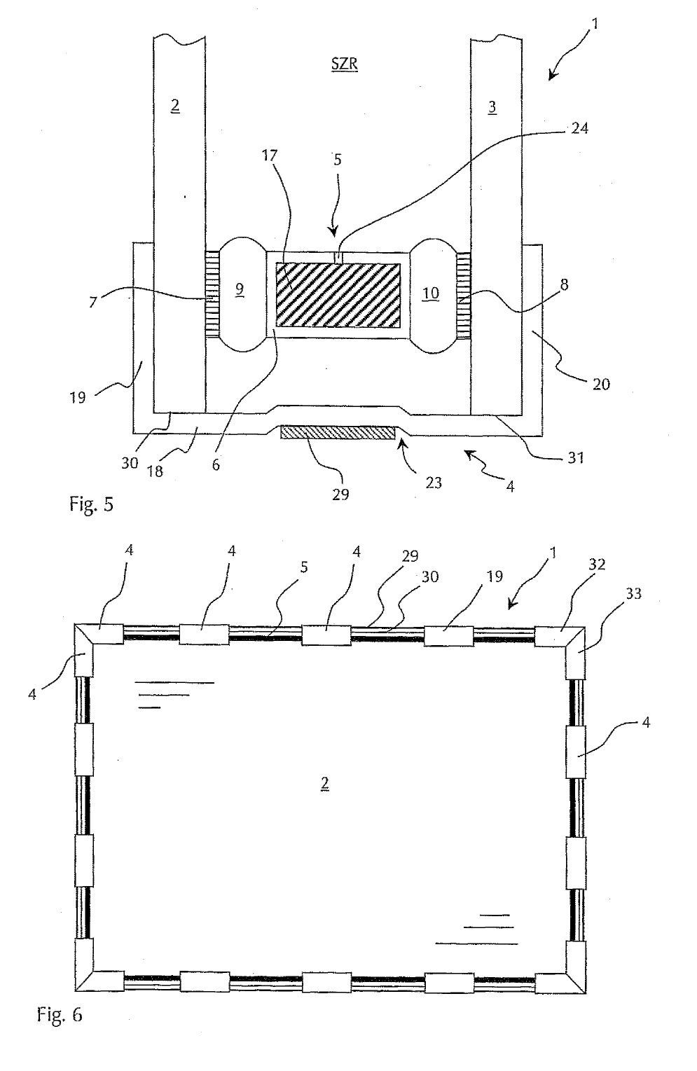

In the fourth embodiment of the insulating glass unit 1 of FIGS. 5 & 6, the sealing element 5 again has two permanently elastic cushions 9, 10 which are not provided with a metal coating. Experiments have shown that metallic surfaces of the cushions 9, 10 may be dispensed with in many applications, since the cushions 9, 10 are usually sufficiently tight to vapor diffusion. To adsorb water vapor from the pane intermediate space SZR, the sealing element 5 has a hollow profile 6 which is open to the desiccant containing cavity 17 through perforations 24.

In this embodiment as well, the glass panes 2, 3 and the sealing element 5 are fixed entirely without the aid of an adhesive, in this case using multiple clamps 4 and a tensioned tension band 29. The tension band 29 is guided in recesses 23 of the clamps 4, and thus, secured against lateral slipping on the clamp backs 18. As may be seen in the side view of the insulating glass unit 1 in FIG. 6, the tension band 29 runs parallel to and around the pane edges 30, 31 of the glass panes 2, 3. In the tensioned installed state, the tension band 29 thus presses all clamps 4 against the pane edges 30, 31 of the glass panes 2, 3, and thus, prevents slipping of both of the panes. 2, 3 and also the clamps 4. In this embodiment, the clamps 4 have linear leg sides 19, 20 projecting perpendicularly from the front side 18. The clamps 4 press the glass panes 2, 3 against the sealing element 5 to form a seal via the legs 19, 20, which press flatly against the glass panes 2, 3.

Special comer clamps 32, 33 are provided on the comers of insulating glass unit 1. These are cut away on their ends facing toward the corners so that they may be situated abutting one another on the corner With a rectangular comer, the comer clamps 32, 33 are thus beveled on their front sides at 45° . Due to the clamps 32, 33 enclosing the comers of the glass panes 2, 3, it is also possible to use a tension band 29 which is narrower than the sealing element 5 without it tensioning in the pane intermediate space SZR. In addition, the comer clamps 32, 33 protect wider tension bands 29 from cuts on the pane edges of the comer interior. The tension band 29 shown here is a flat band made of stainless steel.

1-17. (canceled)

18. An insulating glass unit, comprising:
at least two glass panes,
a fastener for fixing the position of the glass panes, and
a sealing element for setting a distance between the glass panes and for gas-tight lateral insulation of an intermediate space located between the glass panes, the sealing element containing at least a gas-tight middle part and two lateral gap seals, each of which is situated in an area between one of the glass panes and the middle part,
wherein at least one diffusion-tight cushion presses directly against each of the two gap seals, and is situated directly adjoining the middle part.

19. The insulating glass unit according to claim 18, wherein the at least one diffusion-tight cushion comprises a respective diffusion-tight cushion between each of the two gap seals and the middle part of the sealing element and directly adjoins the at least one gap seal and the middle part .

20. The insulating glass unit according to claims 18, wherein the cushion is essentially made of a material which has a Shore-A hardness according to DIN 53505 in the range of 50 N/mm² to 70 N/mm².

21. The insulating glass unit according to claim 18, wherein the cushion is essentially made of an elastomeric plastic from the group consisting of EPDM, polyurethane, an acrylonitrile butadiene elastomer, a chlorobutadiene elastomeric, a fluoroelastomer, and a silicone.

22. The insulating glass unit according to claim 18, wherein the cushion is provided with a gas-tight layer on at least one surface

23. The insulating glass unit according to claim 22, wherein the gas-tight layer is a metal layer.

24. The insulating glass unit according to claim 22, wherein the gas-tight layer is applied to a surface of the cushion facing toward the intermediate space.

25. The insulating glass unit claim 18, wherein the at least one cushion is has been extruded onto the middle part.

26. The insulating glass unit according to claim 18, wherein the gap seal is made of a synthetic, elastomeric plastic.

27. The insulating glass unit according to claim 18, wherein the synthetic, elastomeric plastic is polyisobutylene.

28. The insulating glass unit according to claim 18, wherein each of the gap seals at least partially lies in a trough at a respective side of the sealing element facing toward the respective glass pane.

29. The insulating glass unit according to claim 28, wherein the cushion comprises two profiled strips situated neighboring one another, and wherein the trough is defined between them.

30. The insulating glass unit according to claim 18, wherein the middle part is a gas-tight hollow profile.

31. The insulating glass unit according to claim 30, wherein the gas-tight hollow profile is made of metal and has a cavity in which a desiccant is located.

32. The insulating glass unit according to claim 13, wherein the fastener comprises at least one clamp which externally encloses the glass panes and presses them against the sealing element.

33. The insulating glass unit according to claim 18, wherein the at least one clamp is made of metal.

34. The insulating glass unit according to claim 32, wherein the clamp encloses the entire outer edge of the insulating glass unit.

35. The insulating glass unit according to claim 32, wherein the clamp has a U-shaped cross-section with two leg sides which press on the glass panes, the two leg sides being connected by a front side.

36. The insulating glass unit according to claim 35, wherein at least one of the leg sides of the clamp has at least one bulge directed toward the respective pane.

37. The insulating glass unit according to claim 35, wherein the clamp has at least one bulge on its front side.

38. The insulating glass unit according to claim 32, wherein the at least one fastener is comprised of multiple clamps and a tension band, the tension band being guided on the clamps around the edges of the glass panes and tensioned.

39. The insulating glass unit according to claim 35, wherein the at least one fastener is comprised of multiple clamps and a tension band, the tension band being guided around the edges of the glass panes and tensioned in bulges on the front side of the clamps.
